(19) United States
(12) Patent Application Publication
(10) Pub. No.: US 2023/0051956 A1
(43) Pub. Date: Feb. 16, 2023

(54) SMART MIRROR CAPABLE OF REMOTELY OPERATING A MOBILE DEVICE

(71) Applicant: Capstone Industries, Inc., Deerfield Beach, FL (US)

(72) Inventor: Stewart WALLACH, Delray Beach, FL (US)

(73) Assignee: Capstone Industries, Inc., Deerfield Beach, FL (US)

(21) Appl. No.: 17/573,289

(22) Filed: Jan. 11, 2022

Related U.S. Application Data
(60) Provisional application No. 63/233,601, filed on Aug. 16, 2021.

(51) Int. Cl. G06F 3/14; G06F 3/044; H04W 4/80; A47G 1/02

(52) U.S. Cl. CPC G06F 3/1454; G06F 3/0446; H04W 4/80; A47G 1/02

(57) ABSTRACT

A smart-mirror device capable of controlling a remote mobile device based on a screen that is cast from the mobile device and displayed in a touch-screen mirror of the smart-mirror device. The touch-screen mirror can include a display area that functions as a touch screen. In an embodiment, a user can initiate a screen-mirroring process to cast the screen of the mobile device to a screen-mirroring area arranged within the display area of the touch-screen mirror. The user can then interact with the screen-mirroring area while viewing the screen that is cast from the mobile device. Converted position information of the user's touches can be transmitted to the mobile device, for example, through a Bluetooth human interface device (HID) configured at the smart-mirror device or by using any other wireless transmission protocols and technologies.

### INCORPORATION BY REFERENCE

This present application claims the benefit of U.S. Provisional Application No. 63/233,601, “Smart Mirror Capable of Remotely Operating a Mobile Device” filed on Aug. 16, 2021, which is incorporated herein by reference in its entirety.

### TECHNICAL FIELD

The present disclosure relates to smart-mirror technologies that enable a smart-mirror device to bidirectionally communicate with a remote mobile device.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

A smart mirror typically consists of a computer and a monitor disposed behind a mirror. When the monitor is turned on, a user can see images displayed on the monitor emerging from the reflective surface of the mirror. When the monitor is turned off, the smart mirror appears to be a regular mirror in front of the user. Controlled by the computer system, real-time information from the Internet, such as daily news, traffic conditions, weather, calendar events, or the like, can be presented in the mirror.

Advanced smart mirrors can be configured with a touch screen, a camera, a microphone, speakers, and various sensors, thereby having enhanced capabilities for interacting with users. For example, a user can operate a touch-enabled smart mirror to perform tasks such as website browsing, email checking, visiting social networks, online streaming, or the like.

### SUMMARY

While using a smart mirror, a user may desire to connect a smart mirror to a mobile device to view a mirrored screen of the mobile device that is cast to the smart mirror. During such use, the user may desire to operate the mobile device remotely by interacting with the mirrored screen displayed in the smart mirror, instead of having to interact with the mobile device directly.

Aspects of the disclosure provide a smart-mirror device capable of controlling a remote mobile device based on a screen that is cast from the mobile device and displayed in a touch-screen mirror of the smart-mirror device. The touch-screen mirror can include a display area that functions as a touch screen. In an embodiment, a user can initiate a screen-mirroring process to cast the screen of the mobile device to a screen-mirroring area arranged within the display area of the touch-screen mirror. The user can then interact with the screen-mirroring area while viewing the screen that is cast from the mobile device.

A touch panel covering the display area of the touch-screen mirror can detect a touch of the user and output touch position information (for example, x and y coordinates) corresponding to the resolution of the display area. The touch position information (x and y coordinates) corresponding to the resolution of the display area can be converted to touch position information corresponding to the resolution of the screen of the mobile device performing screen mirroring. The converted position information can then be transmitted to the mobile device, for example, through a Bluetooth human interface device (HID) configured at the smart-mirror device or based on any other wireless transmission protocols and technologies.

Aspects of the disclosure provide a method. The method can include displaying content shown on a screen of a mobile device in a screen-mirroring area in a touch-screen of a local device based on a screen-mirroring scheme, detecting on the screen-mirroring area a touch of a user of the local device, and transmitting to the mobile device a wireless signal indicating a position of the touch on the screen-mirroring area.

An embodiment of the method can further include converting a first set of horizontal and vertical coordinates of the touch on the screen-mirroring area to a second set of horizontal and vertical coordinates. The first set of horizontal and vertical coordinates can be based on a first resolution of the touch-screen of the local device. The second set of horizontal and vertical coordinates can be based on a second resolution of the screen of the mobile device.

In an embodiment, the conversion of the first set of horizontal and vertical coordinates of the touch on the screen-mirroring area to the second set of horizontal and vertical coordinates is based on the first set of horizontal and vertical coordinates of the touch on the screen-mirroring area that are based on the first resolution of the touch-screen of the local device, a position of the screen-mirroring area in the touch-screen of the local device, and the second resolution of the screen of the mobile device. In an embodiment, the position of the touch on the screen-mirroring area indicated by the wireless signal is represented by the second set of horizontal and vertical coordinates based on the second resolution of the screen of the mobile device.

In an embodiment, the wireless signal is a Bluetooth transmission signal that is broadcast to the mobile device from a Bluetooth accessory device in the local device. In some embodiments, the wireless signal can be based on any other wireless transmission protocols and technologies than the Bluetooth protocols and technologies. In an embodiment, the Bluetooth accessory device is a Bluetooth human input device (HID). In some embodiments, accessory devices based on other types of wireless transmission protocols and technologies can be employed. In various embodiments, the screen-mirroring scheme can be a wired or wireless screen mirroring scheme. In various embodiments, the screen-mirroring scheme can be based on a Miracast protocol, a Google Cast protocol, an AirPlay protocol, or any other screen casting protocols. In an embodiment, the local device is a smart-mirror device that has a touch-screen mirror. The touch-screen mirror includes the touch screen.

Aspects of the disclosure provide an apparatus. The apparatus can include a touch-screen and circuitry configured to receive content shown on a screen of a mobile device from the mobile device based on a screen-mirroring scheme, display the content shown on the screen of the mobile device in a screen-mirroring area in the touch-screen, detect on the screen-mirroring area a touch of a user, and transmit to the mobile device a wireless signal indicating a position of the touch on the screen-mirroring area.

Aspects of the disclosure further provide a non-transitory computer-readable medium storing instructions that, when executed by a processor, cause the processor to perform the method.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary smart-mirror device interacting with a mobile device according to embodiments of the disclosure.

FIG. 2 shows an exemplary smart-mirror device capable of controlling a remote mobile device according to an embodiment of the disclosure.

FIG. 3 shows an exemplary coordinate conversion process according to an embodiment of the disclosure.

FIG. 4 shows an exemplary process of controlling a mobile device from a smart-mirror device according to an embodiment of the disclosure.

### DETAILED DESCRIPTION OF EMBODIMENTS

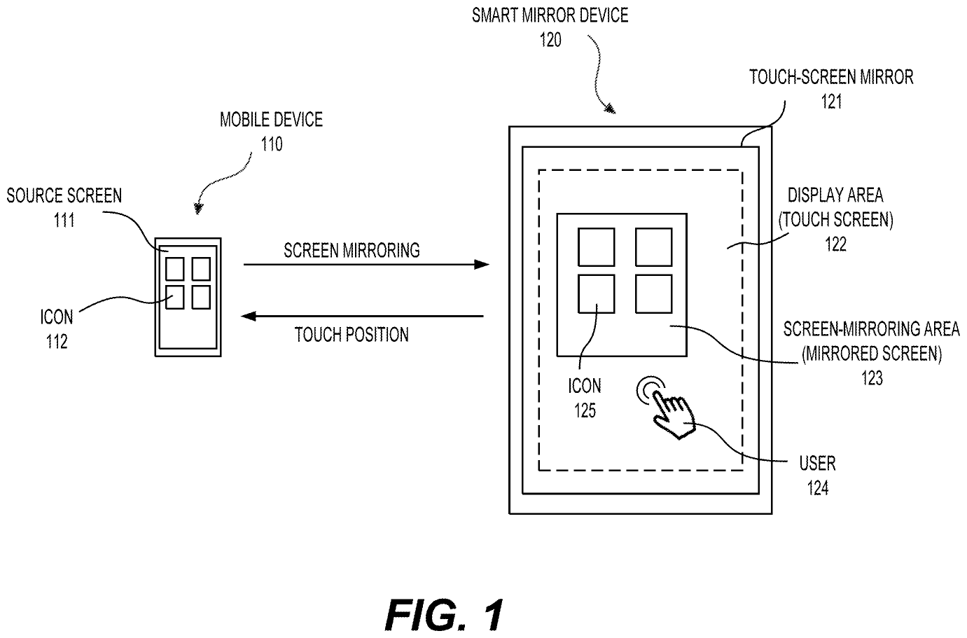

FIG. 1 shows a scenario where a user 124, in front of a smart-mirror device 120, can interact with the smart-mirror device 120 to control a remote mobile device 110 to cast content to the smart-mirror device 120. The mobile device 110 can be any electronic device capable of transmitting content to the smart mirror device 120, such as a mobile phone, a tablet, a laptop, a smart TV, a smart watch, another smart-mirror device, or the like. The mobile device 110 has a screen 111 (also referred to as a source screen). As an example, icons 112 are displayed on the source screen 111. The smart-mirror device 120 has a mirror 121 (also referred to as a touch-screen mirror) and a display area 122 therein.

The display area 122 can function as a touch screen 122. For example, the display area 122 can have a multi-layer structure. The multi-layer structure may include a display layer (such as a display panel), a reflective layer (such as a mirror surface), and a touch sensor layer (such as a touch panel). Additionally and optionally, a substrate layer (made of plastic or glass materials) and a cover layer may be employed. Those layers can be stacked together in various ways to form the display area 122 in various embodiments. In an example, the reflective layer and the substrate layer may extend outward from the display area 122 and form the touch-screen mirror 121. In some examples, the display area 122 and the touch-screen mirror 121 may have a same size and overlap each other. In such a case, the whole area of the touch-screen mirror 121 operates as a touch screen.

The smart-mirror device 120 can be equipped with a computer system (not shown in FIG. 1). The computer system can be configured with a central processing unit (CPU) and a memory. An operating system and software applications can be installed on the computer system. information or content from the Internet or other sources can be displayed in the display area 122 based on the local computer system.

A screen-mirroring process can be initiated to cast the source screen 111 of the mobile device 110 to the touch-screen mirror 121 of the smart-mirror device 120. As a result, a mirrored screen 123 can appear in a screen-mirroring area 123. The screen-mirroring area 123 can be smaller than the display area 122, thereby floating within the display area 122. Or, the screen-mirroring area 123 can occupy the complete display area 122. Where the screen-mirroring area 123 is arranged over the display area 122 can depend on a configuration of the smart-mirror device 120. Or, the user 124 can control a size of the screen-mirroring area 123 and where to dispose the screen-mirroring area 123 in the display area 122, for example, by touching the touch screen 122.

While the screen-mirroring process is being carried on, using the techniques disclosed herein, the user 124 can interact with the mirrored screen 123 to operate the remote mobile device 110. As a result, intended content from the source screen 111 can be displayed on the mirrored screen 123 in real time, as if the user 124 is directly operating on the mobile device 110.

For example, an icon 112 is displayed on the source screen 111. An icon 125 corresponding to the icon 112 is displayed on the mirrored screen 123. When the user 124 touches the icon 125, a touch panel covering the display area 122 can detect the touch and output touch position information. Based on the detected touch position, a wireless signal, for example, indicating a touch position can be transmitted to the mobile device 110. The mobile device 110 responds to the indicated touch position as if responding to the user 124 touching the icon 112 locally on the source screen 111. What is displayed on the source screen 111 as a response to the indicated touch position can be promptly cast to the mirrored screen 123.

While some smart-mirror devices are themselves stand-alone computer systems and capable of accessing the Internet, there can be many reasons why a user or a smart-mirror supplier may desire the feature of casting a screen of a mobile device to a smart-mirror device. For example, a computer system within a mart-mirror device typically has a cheaper configuration (for example, less powerful CPU, less storage) than a mobile phone due to cost restrictions. Thus, a smart-mirror user may want to access to the resources and functions of a mobile phone. Also, installation and setup of a large number of applications can be time-consuming. A smart-mirror user may wish to skip this process over a smart mirror device. Further, some smart-mirror devices may not be allowed to install specific software suites due to license restrictions. Support of screen mirroring can be a choice of a manufacturer to design around such a restriction.

While watching a mirrored screen in a smart mirror, a user may further desire the convenience of interacting with the mirrored screen to control what is to be displayed, instead of approaching a mobile device that is casting to the smart mirror. The current disclosure provides the techniques enabling users to interact with a mirrored screen in a mirror of a smart-mirror device to control the content cast from a remote mobile device.

In the FIG. 1 example, the screen-mirroring process can be based on various screen-mirroring technologies or protocols depending on configurations of the mobile device 110 and the smart-mirror device 120. In an example, the mobile device 110 and the smart-mirror device 120 can be connected to a local wireless network, such as a Wi-Fi network, and the screen mirroring is performed in a wireless manner through the local wireless network. Examples of wireless screen-mirroring protocols can include Miracast developed by Wi-Fi Alliance, AirPlay developed by Apple Inc., and Google Cast developed by Google LLC. In other examples, screen mirroring can be realized based on a wired connection. For example, a video cable supporting an interface of HDMI, VGA, USB, DisplayPort, or the like, can be used to cast (duplicate or extend) a source screen to a smart-mirror device. Any screen-mirroring techniques can be combined with the techniques disclosed herein for remotely control or interact with a mobile device.

In an embodiment, the screen-mirroring process can be initiated at the side of the mobile device 110. For example, the user 124 can operate a screen-mirroring app installed on the mobile device 110 to start screen mirroring. In an embodiment, the screen-mirroring process is initiated at the side of the smart-mirror device 120. For example, the user 124 can operate an app installed on the smart-mirror device 120 to trigger the screen-mirroring process. An authentication may optionally be performed before the user 124 is allowed to access the mobile phone.

In an embodiment, the touch position information generated from the touch screen 122 is carried in a wireless signal and transmitted to the mobile device 110. For example, a Bluetooth human interface device (HID), such as an HID mouse or touch panel, can be configured at the smart-mirror device 120. When the mobile device 110 is in the proximity of the smart-mirror device 120, automatic pairing can be performed to establish a Bluetooth connection between the mobile device 110 and the smart-mirror device 120. The touch position information can be converted to a Bluetooth transmission signal that is broadcast to the mobile device 110. In another example, the transmission of the touch position can be performed over a local wireless network, such as a Wi-Fi network. In another embodiment, the transmission of the touch position can be performed over a wired connection, for example, via a table.

While a mobile device is used in the FIG. 1 example for the purpose of illustration, the techniques disclosed herein are not limited to screen mirroring from a mobile device. For example, a screen of a desktop computer can be cast to a smart-mirror device. A user can similarly control the remote desktop computer from the smart-mirror device based on the techniques disclosed herein. For another example, a control panel of an appliance (such as a refrigerator, a heating, ventilation, and air conditioning (HVAC) system, or the like) can be cast to a smart-mirror device. A user can similarly control the appliance remotely.

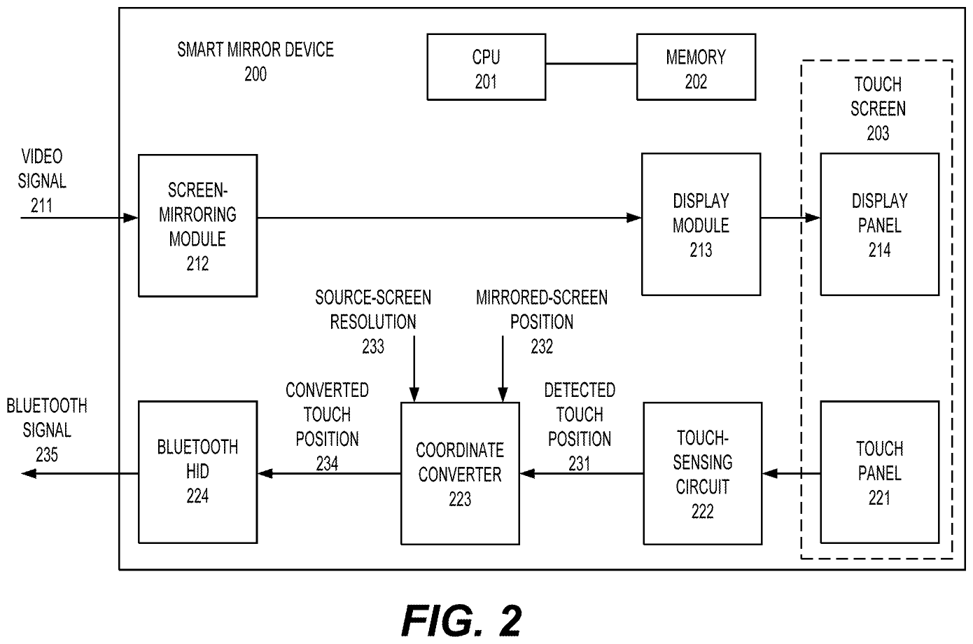

FIG. 2 shows a smart-mirror device 200 according to an embodiment of the disclosure. The smart-mirror device 200 is capable of controlling a remote mobile device performing screen mirroring (or casting) to the smart-mirror device 200. The smart-mirror device 200 can include a CPU 201, a memory 202, a screen-mirroring module 212, a display module 213, a display panel 214, a touch panel 221, a touch sensing circuit 222, a coordinate converter 223, and a Bluetooth HID 224. Those elements are coupled together as shown in FIG. 2. The remote touch control functions can work in parallel with the screen mirroring (or casting) functions. In some example, the remote touch control functions can work independently of the screen mirroring (or casting) functions.

The memory 202 can be configured to store various program instructions or data, such as operating systems, application programs, and the like. The memory 202 can include non-transitory storage media, such as a read-only memory (ROM), a random access memory (RAM), a flash memory, a solid-state memory, a hard disk drive, an optical disk drive, and the like. The CPU 201 can be configured to execute program instructions stored in the memory 202 to perform various functions and processes of the smart-mirror device 200. The CPU 201 may control other modules or components of the smart-mirror device 200 to perform the respective functions in a coordinated manner.

The screen-mirroring module 212, the display module 213, and the display panel 214 can operate together to perform screen mirroring. For example, a video signal 211 can be transmitted from a remote mobile device and received at the screen-mirroring module 212. The video signal 211 can correspond to a sequence of pictures displayed on a source screen of the mobile device. The sequence of pictures can be encoded or compressed before being converted to the video signal 211. The screen-mirroring module 212 can decode or decompress the video signal 211 to recover the sequence of pictures and provide the sequence of pictures to the display module 213. The display module 213 receives the sequence of pictures and converts the pictures to signals suitable for display by the display panel 214. The display panel 214 can be a liquid-crystal display (LCD), a light-emitting diode (LED) display, or the like.

The display panel 214 and the touch panel 221 can form a display area 203 (touch screen 203) of the smart-mirror device 200. The touch screen 203 can be a portion of a reflective area (a mirror) of the smart-mirror device 200 (similar to the display area 122 arranged within the touch-screen mirror 121 in the FIG. 1 example) or occupy the whole reflective area.

The touch panel 221 serves as a touch sensor and can be configured to generate signals indicating positions of one or more touches over the touch panel 221. Various touch sensing mechanisms can be employed in various embodiments, such as resistive film touch panel, capacitive touch panel, surface acoustic wave touch panel, optical touch panel (infrared), induction touch panel, and the like.

The touch sensing circuit 222 processes the touch-sensing signals from the touch panel 221 and output coordinates of the one or more touches. Those coordinates are referred to as detected coordinates and represent one or more detected touch positions 231. For example, a pair of x and y coordinates (horizontal and vertical coordinates) can represent one touch position 231. The detected coordinates 231 can be determined based on a resolution of the touch panel 221 that output the touch-sensing signals. In other examples, other types of coordinate systems, such as a polar coordinate system, may be used in place of a Cartesian coordinate system in the smart mirror device 200.

In some embodiments, a touch panel calibration process can be performed to determine a set of adjustment factors. The adjustment factors can be applied to the detected coordinates to improve accuracy of the touch positions. For example, in a calibration process, a user can touch a top-left corner and a bottom-right corner of an active area (such as the display panel 214). In response, the corresponding coordinates (x_left, y_left) and (x_right, y_right) can be output from the touch sensing circuit 222.

A touch position (x_m1, y_m1) can be send to the display module 213 to display a mouse position on the display panel 214. The user can be prompt to touch the displayed mouse position. In response, a detected position (x_m_actual, y_m_actual) can be obtained. Accordingly, a pair of adjustment calibration factors can be determined as follows:

x_factor=(x_m_actual−x_left)/x_m1 (1)

y_factor=(y_m_actual−y_left)/y_m1 (2)

Multiple mouse positions can be displayed to obtain averaged adjustment factors.

When the user touch the active area, detected coordinates (x_touch, y_touch) can be adjusted as follows:

x_adjusted=(x_touch−x_left)/x_factor (3)

y_adjusted=(y_touch−y_left)/y_factor (4)

The adjusted coordinates (x_adjusted, y_adjusted) can be used as a detected touch position 231.

The coordinate converter 223 receives the detected touch positions 231 and converts the detected touch positions 231 to converted touch positions 234. For example, the detected coordinates are converted to converted coordinates that are based on a resolution of the source screen of the mobile device that is being cast to the display panel 214. As part of the calibration process, the target phone screen resolution is identified during the screen casting process and incorporated into the touch screen calibration algorithm to convert touch screen position between the input of the mirror touch screen and the target device.

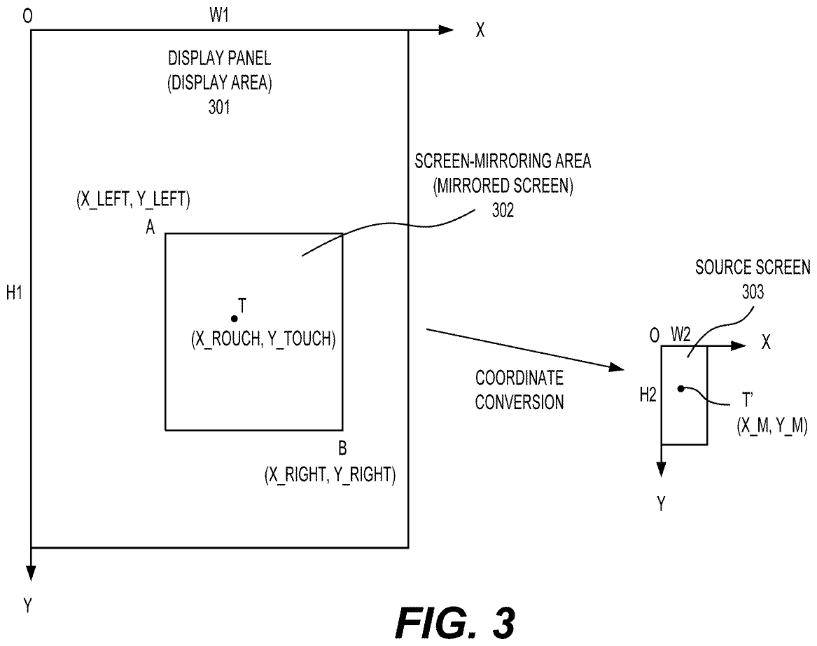

FIG. 3 shows an example of converting a detected touch position (denoted by T) on a mirrored screen 302 to a converted touch position (denoted by T′) on a source screen 303. As shown, a display panel 301 (such as the display area 122 in FIG. 1) has a resolution of W1×H1 pixels. The mirrored screen 302 (a screen-mirroring area, such as the mirrored screen 123 in FIG. 1) is disposed within the display panel 301. A top-left corner (denoted by A) of the screen-mirroring area 302 can have coordinates of (x_left, y_left), while a bottom-right corner (denoted by B) of the screen-mirroring area 302 can have coordinates of (x_right, y_right). A touch is detected at the touch position T that has coordinates of (x_touch, y_touch) (that is based on the resolution of the display panel 301).

Accordingly, a first percentage of the total width and a second percentage of the total height of the screen-mirroring area 302 corresponding to the touch position T can be determined as follows:

$$1 st percentage = \frac{x\_touch - x\_left}{x\_righ - x\_left} \qquad ( 5 )$$

$$2 nd percentage = \frac{y\_touch - y\_left}{y\_righ - y\_left} \qquad ( 6 )$$

The converted touch position T′ is shown within the source screen 303 having a resolution of W2×H2 pixels. The coordinates of the converted touch position T′ can be derived as follows:

$$x\_m = W 2 \times 1 st percentage = W 2 \frac{x\_touch - x\_left}{x\_righ - x\_left} \qquad ( 7 )$$

$$y\_m = H 2 \times 2 nd percentage = H 2 \frac{y\_touch - y\_left}{y\_righ - y\_left} \qquad ( 8 )$$

where the coordinates (x_m, y_m) represent the converted touch position T′ and are based on the resolution of the source screen 303.

As illustrated above, the coordinates of a detected touch position can be based on the first resolution of the display panel 301. In contrast, the coordinates of a converted touch position can be based on the second resolution of the source screen 303. In addition, the coordinate conversion can also depend on where the mirrored screen 302 is disposed within the display area 301.

Accordingly, as shown in FIG. 2, the coordinate converter 223 can further receive a mirrored-screen position 232 and a source screen resolution 233 in addition to the detected touch positions 231 in order to perform the coordinate conversion function. In an embodiment, the mirrored-screen position 232 can be provided by the display module 213. For example, the display module 213 can determine a resolution of the screen-mirroring area 302 in FIG. 3 and a position for disposing the screen-mirroring area 302 based on a configuration of the smart-mirror device 200. Or, the display module 213 can determine the resolution and position of the screen-mirroring area 302 based on control input from a user. For example, the user may change the position or size of the screen-mirroring area 302. The display module 213 can accordingly update the change of the resolution or position to the coordinate converter 223.

In an embodiment, the source screen resolution 233 can be provided by the screen-mirroring module 212. For example, the screen-mirroring module 212 can exchange information with the remote mobile device based on a screen-mirroring protocol and thus be aware of the resolution of the source screen.

The Bluetooth HID 224 can receive one or more converted touch positions 234 from the coordinate converter 223 and convert the touch positions into a Bluetooth signal 235. The Bluetooth signal 235 can be broadcast to the mobile device that provides the video signal 211. In various embodiments, different types of HID devices can be configured for generating the Bluetooth signal 235. In some embodiments, various wireless technologies other than the Bluetooth based technologies can be employed for convey of the touch positions from the smart-mirror device 200 to the target mobile device. The current disclosure is not limited to the Bluetooth based technologies.

In an example, the Bluetooth HID 224 is configured to be a Bluetooth-HID-compliant touch panel device. For example, an HID descriptor can be configured to define a feature set of the touch panel device. The touch panel device can receive one or more touch positions 234 and prepare an HID report based on the respective HID descriptor. During a pairing process, the Bluetooth HID 224 can be registered as a touch panel device at the host (the remote mobile device casting the video signal 211), and the HID descriptor can be transmitted to the remote mobile device. The remote mobile device thus can interpret the HID report based on the received HID descriptor to obtain the touch position information and respond accordingly.

In another example, the Bluetooth HID 224 is configured to be a Bluetooth-HID-compliant mouse device (or pointing device). Similarly, an HID descriptor can be configured to define a feature set of the mouse device, and an HID report can accordingly be prepared to indicate the one or more touch positions 234. During a pairing process, the Bluetooth HID 224 can be registered as a Bluetooth mouse.

It is noted that the structure of the smart-mirror device 200 implementing the techniques described herein can be different from that shown in FIG. 2. For example, the smart-mirror device 200 may include different components. The functions of the components may be organized differently into modules. Other types of display devices, such as cathode-ray tube (CRT), organic light-emitting diode (OLED), or the like, may be used to display the mirrored screen. In addition, other wireless or wired technologies may be used in place of Bluetooth for transmission of the converted touch positions 234. Examples of those technologies can include Wi-Fi based technologies, cellular mobile networks, and the like.

In various embodiments, the functions and modules of the smart-mirror device 200 can be implemented by hardware (circuitry), software (instructions), or a combination thereof.

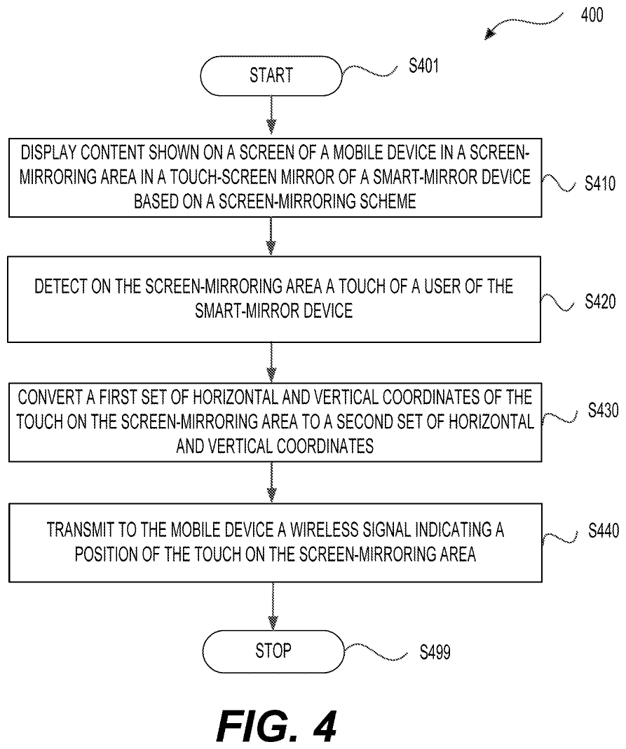

FIG. 4 shows a process 400 of controlling a remote mobile device through a mirrored screen that is cast from the remote mobile device to a smart-mirror device. The process 400 can start from S401 and proceed to S410.

At S410, the content shown on a screen of the mobile device can be displayed in a screen-mirroring area in a touch-screen mirror of the smart-mirror device based on a screen-mirroring scheme. The screen-mirroring scheme can be a wired or wireless screen mirroring scheme. The screen-mirroring scheme can be based on a Miracast protocol, a Google Cast protocol, an AirPlay protocol, or the like.

At S420, a touch of a user of the smart-mirror device can be detected on the screen-mirroring area. The touch can be performed with a hand of the user or a tool (such as a touch panel pen).

At S430, a first set of horizontal and vertical coordinates of the touch on the screen-mirroring area can be converted to a second set of horizontal and vertical coordinates. The first set of horizontal and vertical coordinates can be based on a first resolution of a display area in the touch-screen mirror of the smart-mirror device. The second set of horizontal and vertical coordinates can be based on a second resolution of the screen of the mobile device. The conversion can be based on the first set of horizontal and vertical coordinates, a position of the screen-mirroring area in the display area in the touch-screen mirror of the smart-mirror device (for example, the position of the screen-mirroring area can be indicated by positions of two corners of the screen-mirroring area), and the second resolution of the screen of the mobile device.

At S440, a wireless signal indicating a position of the touch on the screen-mirroring area can be transmitted to the mobile device. For example, the position of the touch on the screen-mirroring area indicated by the wireless signal can be represented by the second set of horizontal and vertical coordinates based on the second resolution of the screen of the mobile device. The wireless signal can be a Bluetooth transmission signal that is broadcast to the mobile device from a Bluetooth accessory device in the smart-mirror device. In an example, the Bluetooth accessory device is a Bluetooth HID, such as a Bluetooth HID mouse device, a Bluetooth HID touch panel device, or the like. The process 400 can proceed to S499 and terminates at S499.

While smart mirrors are used as examples for illustration purposes, the techniques of interacting with a local touch screen to operate a remote mobile (or non-mobile) device can be applied to an apparatus having a form other than a smart mirror. For example, in various embodiments, an apparatus implementing the techniques disclosed herein can be a piece of furniture (such as a desk) or a wall-handing item embedded with a touch display, a vehicle (a car, a train, a boat, an aircraft, or the like) with an embedded touch display, a television or a digital picture display configured with a touch panel, a mobile phone, a tablet or a laptop having a touch screen, or the like. Some apparatus can be disposed in a workplace environment or a living-place environment.

The above-described apparatus implementing the techniques disclosed herein can include functions or components similar to the FIG. 2 example. However, different from the FIG. 2 example where the components 201, 202, 212-214, and 221-224 are integrated with a mirror assembly, these components can be combined with other structures of the respective apparatus. In some examples, some components, such as the CPU 201, the memory 202, the display module 213, the display panel 214, the touch-sending circuit 222, and the touch panel 221, can be shared between the remote-device-control functions and other functions fulfilled by the respective apparatus.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a non-transitory computer-readable medium providing program instructions for use by or in connection with a computer or any instruction execution system. The computer-readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non-transitory storage medium can include all types of computer-readable medium, including magnetic storage medium, optical storage medium, flash medium, and solid-state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
displaying content shown on a screen of a mobile device in a screen-mirroring area in a touch-screen of a local device based on a screen-mirroring scheme;
detecting on the screen-mirroring area a touch of a user of the local device; and
transmitting to the mobile device a wireless signal indicating a position of the touch on the screen-mirroring area.

2. The method of claim 1, further comprising:
converting a first set of horizontal and vertical coordinates of the touch on the screen-mirroring area to a second set of horizontal and vertical coordinates, the first set of horizontal and vertical coordinates being based on a first resolution of the touch-screen of the local device, the second set of horizontal and vertical coordinates being based on a second resolution of the screen of the mobile device.

3. The method of claim 2, wherein the conversion of the first set of horizontal and vertical coordinates of the touch on the screen-mirroring area to the second set of horizontal and vertical coordinates is based on:
the first set of horizontal and vertical coordinates of the touch on the screen-mirroring area that are based on the first resolution of the touch-screen of the local device,
a position of the screen-mirroring area in the touch-screen of the local device, and
the second resolution of the screen of the mobile device.

4. The method of claim 2, wherein the position of the touch on the screen-mirroring area indicated by the wireless signal is represented by the second set of horizontal and vertical coordinates based on the second resolution of the screen of the mobile device.

5. The method of claim 1, wherein the wireless signal is a Bluetooth transmission signal that is broadcast to the mobile device from a Bluetooth accessory device in the local device.

6. The method of claim 5, wherein the Bluetooth accessory device is a Bluetooth human input device (HID).

7. The method of claim 1, wherein the screen-mirroring scheme is a wired or wireless screen mirroring scheme.

8. The method of claim 1, wherein the screen-mirroring scheme is based on a Miracast protocol, a Google Cast protocol, or an AirPlay protocol.

9. The method of claim 1, wherein the local device is a smart-mirror device that has a touch-screen mirror, the touch-screen mirror including the touch screen.

10. An apparatus, comprising:
a touch-screen;
circuitry configured to:
receive content shown on a screen of a mobile device from the mobile device based on a screen-mirroring scheme,
display the content shown on the screen of the mobile device in a screen-mirroring area in the touch-screen,
detect on the screen-mirroring area a touch of a user, and
transmit to the mobile device a wireless signal indicating a position of the touch on the screen-mirroring area.

11. The apparatus of claim 10, wherein the circuitry is further configured to:
convert a first set of horizontal and vertical coordinates of the touch on the screen-mirroring area to a second set of horizontal and vertical coordinates, the first set of horizontal and vertical coordinates being based on a first resolution of the touch-screen, the second set of horizontal and vertical coordinates being based on a second resolution of the screen of the mobile device.

12. The apparatus of claim 11, wherein the conversion of the first set of horizontal and vertical coordinates of the touch on the screen-mirroring area to the second set of horizontal and vertical coordinates is based on:
the first set of horizontal and vertical coordinates of the touch on the screen-mirroring area that are based on the first resolution of the touch-screen,
a position of the screen-mirroring area in the touch-screen, and
the second resolution of the screen of the mobile device.

13. The apparatus of claim 11, wherein the position of the touch on the screen-mirroring area indicated by the wireless signal is represented by the second set of horizontal and vertical coordinates based on the second resolution of the screen of the mobile device.

14. The apparatus of claim 10, wherein the wireless signal is a Bluetooth transmission signal that is broadcast to the mobile device from a Bluetooth accessory device in the apparatus.

15. The apparatus of claim 14, wherein the Bluetooth accessory device is a Bluetooth human input device (HID).

16. The apparatus of claim 10, wherein the screen-mirroring scheme is a wired screen-mirroring scheme or a wireless screen-mirroring scheme.

17. The apparatus of claim 10, wherein the screen-mirroring scheme is based on a Miracast protocol, a Google Cast protocol, or an AirPlay protocol.

18. The apparatus of claim 10, wherein the apparatus is a smart-mirror device that has a touch-screen mirror, the touch-screen mirror including the touch screen.

19. A non-transitory computer-readable medium storing instructions that, when executed by a processor, cause the processor to perform a method, the method comprising:
displaying content shown on a screen of a mobile device in a screen-mirroring area in a touch-screen of a local device based on a screen-mirroring scheme;
detecting on the screen-mirroring area a touch of a user of the local device; and
transmitting to the mobile device a wireless signal indicating a position of the touch on the screen-mirroring area.

20. The non-transitory computer-readable medium of claim 19, wherein the method further comprises:
converting a first set of horizontal and vertical coordinates of the touch on the screen-mirroring area to a second set of horizontal and vertical coordinates, the first set of horizontal and vertical coordinates being based on a first resolution of the touch-screen of the local device, the second set of horizontal and vertical coordinates being based on a second resolution of the screen of the mobile device.
